(19) United States
(12) Patent Application Publication
(10) Pub. No.: US 2005/0048975 A1
(43) Pub. Date: Mar. 3, 2005

(54) Method and apparatus for node B controlled scheduling in soft handover

(76) Inventors: Karri Ranta-Aho, Espoo (FI); Tero Henttonen, Espoo (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/648,778

(22) Filed: Aug. 25, 2003

(51) Int. Cl. H04Q 7/20

(52) U.S. Cl. 455/438; 455/436

(57) ABSTRACT

A method (20) and corresponding equipment for enabling Node B based control during soft handover of the maximum allowed uplink data rate used by a UE device (11), based on the UE device (11) identifying a scheduling cell in an uplink, and the Node Bs (10 10′) receiving the uplink each determining whether it is in control of the scheduling cell and providing commands to affect the maximum allowed uplink data rate only if it is in control. In case of differential scheduling and a change in the scheduling cell to a new scheduling cell under the control of a different one of the Node Bs (10 10′), a synchronization process is carried out so as to set to a same value a pointer (10a′) used by the new scheduler Node B (10′) to indicate the maximum allowed uplink data rate and a corresponding pointer (11a) used by the UE device (11).

### TECHNICAL FIELD

The present invention pertains to the field of wireless communication, especially via telecommunication networks according to 3GPP specifications. More particularly, the present invention pertains to uplink performance in the UMTS radio access network, UTRAN, and even more particularly, the invention is related to Node B controlled scheduling.

### BACKGROUND

An UMTS (Universal Mobile Telecommunication System) network includes a core network of various elements and also a radio access network, called UTRAN (UMTS terrestrial radio access network). A UTRAN includes radio network controllers (RNCs) that control so-called Node Bs, that in turn wirelessly communicate with UE (user equipment) devices, i.e. e.g. mobile phones. UMTS networks are provided and operated as specified by 3GPP (Third Generation Partnership Program) specifications, which are evolving, and which are issued in successive releases.

In the most current evolution, which will issue as release 6, a proposal has been made for a fast Node B controlled scheduling mechanism requiring both the UE and the Node B to individually maintain a data rate pointer for the UE maximum allowed UL (uplink) data rate, as indicated in a transport format combination indicator (TFCI) data object. The data rate pointer is updated using differential signaling (increase/decrease), and so if the UE and the Node B do not have the same understanding of the current pointer value, a Node B command (a granted request or a command without a corresponding request) to increase or decrease the data rate will result in a data rate different than expected by the Node B. According to the proposal, a UE can only request a change of the data rate pointer (using rate request signaling), and the Node B is in control; if it finds a rate request from a UE acceptable, it updates its own pointer entity and signals a rate grant to the UE.

In soft handover (SHO)—a situation in which a UE is connected at the same time to more than one Node B and receives downlink transmissions from each—there would be more than one Node B trying to schedule a UE in case of Node B based scheduling, i.e. there would be more than one Node B sending commands to a UE to increment or decrement the UE pointer. One proposed option is to allow at any time (such as in SHO) only one Node B to schedule the UE, what is here called the scheduler. Still, two problems remain: first, the Node Bs are not aware that the UE is in SHO, and so cannot cooperate or agree on which Node B is to be the scheduler; and second, even if it could somehow be arranged that only one Node B at a time performs scheduling, if the Node B doing so changes from one Node B to another, the (UE) data rate pointer in the UE and the (UE) data rate pointer in the Node B newly performing the scheduling are likely to be different (since the new scheduler did not necessarily adjust its pointer based on commands sent to the UE by the previous scheduler).

The two-pointer (one in a UE and a corresponding pointer in the Node B, each for indicating the maximum allowed rate of uplink by the UE) rate scheduling method has been described in 3GPP Technical Report (TR) 25.896:
http://www.3gpp.org/ftp/tsg_ran/WG1_RL1/TSGR1_{—}32/Docs/Zips/R1-030635.zip

Three different alternatives for scheduling in SHO have been proposed in the 3GPP and included in 3GPP TR25.896:

In the first alternative, all the Node Bs controlling respective radio links in the active set of a UE (the set of Node Bs involved in SHO) schedule the UE in parallel and the scheduling commands from the different Node Bs are somehow combined. (This seems to be difficult to practically implement so as to be fast enough with differential signaling for the pointer updates as all the Node Bs should somehow have the same value for their data rate pointer.) Note that an active set is the set of radio links over which a UE communicates with a radio access network. Each (different) radio link is associated with a respective (different) cell, and each cell with a respective (different) Node B. Thus, an active set can be considered either a set of radio links, or a set of (corresponding) cells, or a set of (corresponding/controlling) Node Bs.

In the second alternative, only one of the Node Bs controlling a radio link in the active set of the UE schedules the UE. (The proposal for the second alternative does not specify whether only the UE knows which cell/Node B is the scheduling cell/Node B or if all the Node Bs controlling a radio link in the active set are privy to the information.)

In the third alternative, the scheduled mode is turned off during SHO, i.e. the UE ignores any commands to adjust its pointer received when it is in SHO, or, alternatively, Node Bs do not issue such commands to a UE in SHO. (How the Node Bs would know a UE is in SHO is not specified.)

None of the alternative proposals is completely satisfactory, and so what is still needed is a mechanism making possible fast Node B based scheduling during SHO.

One piece of prior art used by the invention as described below is that, for Site Selection Diversity Transmit (SSDT) power control, a method has been defined by which a UE selects a primary cell from among the cells the UE is connected to by a respective radio link in its active set, and then informs the Node Bs controlling the radio links in the active set of the primary cell selection. See 3GPP Technical Specification (TS) 25.214, chapter 5.2.1.4.

### DISCLOSURE OF THE INVENTION

Accordingly, in a first aspect of the invention, a method is provided for use by a user equipment (UE) device and Node Bs of a wireless telecommunication system, the method for enabling Node B based control during soft handover of the maximum data rate allowed for uplink by the UE device as indicated by a pointer in the UE device, the soft handover resulting in a change of a controlling Node B from a first one of the Node Bs to a second one of the Node Bs, each of the Node Bs for providing commands for control of UE devices in at least one respective cell so that the UE device in soft handover is simultaneously in at least two cells each possibly controlled by a different one of the Node Bs, the method characterized by: a step in which the UE device signals in uplink information indicating one of the cells as a scheduling cell; a step in which each Node B receiving the uplink indicating one of the cells as the scheduling cell and able to provide scheduling commands determines whether it is in control of the scheduling cell, and issues scheduling commands for controlling the pointer in the UE device if it is in control, but issues no such commands if it determines it is not in control of the scheduling cell.

In accord with the first aspect of the invention, the method may be further characterized by: a step in which the UE device and also the Node B in control of the scheduling cell each synchronize a respective pointer for indicating the maximum allowed uplink data rate for the UE device to a value according to a synchronization procedure. Further still, the method may be even further characterized in that according to the synchronization procedure, the Node B sets the pointer it maintains to the data rate used in the uplink of the information indicating the scheduling cell. Also further still, the method may be even further characterized in that according to the synchronization procedure, the Node B sets the pointer it maintains to a predetermined value. Also further still, the method may be even further characterized in that according to the synchronization procedure, both the Node B and the UE device set their respective pointers according to predetermined criteria. Also further still, the method may be even further characterized in that according to the synchronization procedure, the Node B sets the pointer it maintains to a value it selects and explicitly signals the value to the UE device. Also further still, the method may be even further characterized in that according to the synchronization procedure, the Node B sets the pointer it maintains to the data rate used in the uplink of the information indicating the scheduling cell or to a predetermined value, whichever is greater.

Also in accord with the first aspect of the invention, the Node B based control may be provided using differential signaling or it may be provided using explicit signalling.

In a second aspect of the invention, a UE device is provided comprising: means for wirelessly communicating with Node Bs of a radio access network in a wireless communication system; a pointer for indicating a maximum allowed rate of uplink to the wireless communication system; and means for adjusting the pointer responsive to scheduling commands received from a Node B controlling a cell in which the UE device is located; the UE device characterized in that it comprises: means for uplinking information indicating as a scheduling cell a particular cell from among a plurality of cells involved in a soft handover, each cell possibly controlled by a different Node B.

In accord with the second aspect of the invention, the UE device may be further characterized in that the UE device also comprises: means for selecting as a scheduling cell a particular cell from among a plurality of cells involved in a soft handover.

Also in accord with the second aspect of the invention, the UE device may be further characterized in that the UE device also comprises: means for determining whether scheduling commands are sent by the Node B controlling the scheduling cell and for disregarding all scheduling commands sent by other than the Node B controlling the scheduling cell.

Also in accord with the second aspect of the invention, the UE device may be further characterized in that the UE device also comprises: means for synchronizing the pointer to a corresponding pointer in the Node B controlling the scheduling cell. Further, the UE device may be further characterized in that for synchronization, the it sets the pointer it maintains to the data rate used in the uplink of the information indicating the scheduling cell. Also further, the UE device may be further characterized in that for synchronization, it sets the pointer it maintains to a predetermined value. Also further, the UE device may be further characterized in that for synchronization, it sets the pointer it maintains according to predetermined criteria. Also further, the UE device may be further characterized in that for synchronization, it sets the pointer it maintains to a value explicitly signalled by the Node B. Also further, the UE device may be further characterized in that for synchronization, it sets the pointer it maintains to the data rate used in the uplink of the information indicating the scheduling cell or to a predetermined value, whichever is greater.

In a third aspect of the invention, a Node B is provided comprising means for wirelessly communicating with a user equipment (UE) device as an element of a radio access network of a wireless communication system, characterized in that it comprises: means for determining when to assume control of scheduling of the UE device and when to cease control of scheduling of the UE device based on information uplinked by the UE device indicating as a scheduling cell a particular cell from among a plurality of cells involved in a soft handover.

In accord with the third aspect of the invention, the Node B may further comprise a pointer indicating a maximum allowed rate of uplink by the UE device, and may be further characterized in that it comprises: means by which the Node B synchronizes to the pointer in the UE device a pointer it maintains for indicating the maximum allowed uplink data rate for the UE device. Further, the Node B may be further characterized in that for synchronization, it sets the pointer it maintains to the data rate used in the uplink of the information indicating the scheduling cell. Also further, for synchronization, the Node B may set the pointer it maintains to a predetermined value. Also further, the Node B may be further characterized in that for synchronization, it sets its pointer according to predetermined criteria. Also further, the Node B may be further characterized in that for synchronization, it sets the pointer it maintains to a value it selects and explicitly signals the value to the UE device. Also further, the Node B may be further characterized in that for synchronization, it sets the pointer it maintains to the data rate used in the uplink of the information indicating the scheduling cell or to a predetermined value, whichever is greater.

In a fourth aspect of the invention, a system is provided comprising a plurality of UE devices and a plurality of Node Bs, characterized in that the UE device is according to the second aspect of the invention.

In a fifth aspect of the invention, a system is provided comprising a plurality of UE devices and a plurality of Node Bs, characterized in that at least two of the Node Bs are according to the third aspect of the invention.

In a sixth aspect of the invention, a computer program product is provided comprising: a computer readable storage structure embodying computer program code thereon for execution by a computer processor in a UE device, with said computer program code characterized in that it includes instructions implementing or corresponding to the various means according to the second aspect of the invention, or equivalently, instructions for executing the steps indicated in the first aspect of the invention as performed by a UE device.

In a seventh aspect of the invention, a computer program product is provided comprising: a computer readable storage structure embodying computer program code thereon for execution by a computer processor in a Node B, with said computer program code characterized in that it includes instructions implementing or corresponding to executing the steps recited in claim 1 as executed by a Node B, or equivalently, instructions for executing the steps indicated in the first aspect of the invention as performed by a Node B.

### BRIEF DESCRIPTION OF THE DRAWINGS

The above and other objects, features and advantages of the invention will become apparent from a consideration of the subsequent detailed description presented in connection with accompanying drawings, in which:

FIG. 1 is a block diagram/flow diagram of a UE device and Node Bs having radio links in the active set of the UE and communicating data and related signaling with the UE, some of the indicated communications being according to the prior art and some according to the invention.

FIG. 2 is a flow chart of signaling between a UE in soft handover and Node Bs having radio links in the active set of the UE, according to the invention.

### BEST MODE FOR CARRYING OUT THE INVENTION

The invention provides a way for a UE to receive from a Node B commands changing its maximum allowed uplink rate during soft handover, i.e. during times when the UE may be in communication with more than one Node B (at the same time) via respective radio links of respective different. There is exactly one radio link per cell and exactly one Node B controlling each cell and the corresponding respective radio link, and the set of such radio links (and therefore the set of corresponding cells or corresponding Node Bs) make up what is here called the active set of the UE.

The scheduling commands are typically provided by a Node B to the UE as differential commands, i.e. commands to increase or decrease (the value of) a pointer indicating the maximum allowed rate for uplink, as opposed to explicit/absolute commands indicating a particular value to which (the value of) the pointer is to be changed. As indicated below, however, the invention also encompasses not only differential signaling by Node Bs controlling the radio links in the active set, but also explicit signaling (i.e. signaling of values for maximum allowed rates, as opposed to signaling increments or decrements to an assumed maximum allowed rate).

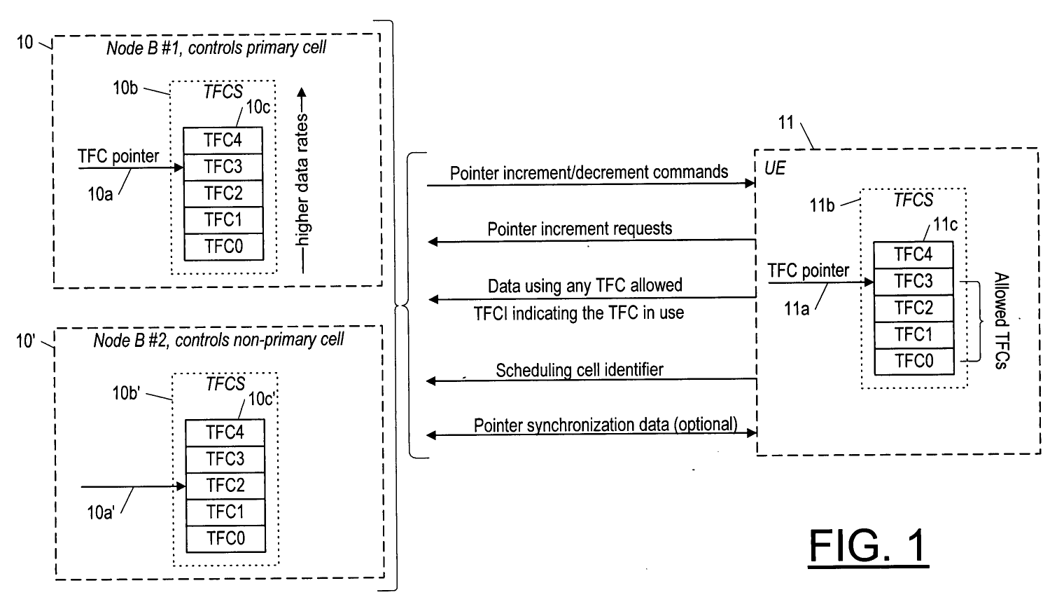

As shown in FIG. 1, a UE 11 and each Node B 10 10′ controlling a respective radio link in the active set of the UE—assumed here to consist of the radio links controlled by two Node Bs, a first Node B 10 and a second Node B 10′—maintain a TFCS (Transport Format Combination Set) 10b 10b′ 11b including a set of TFCs 10c 10c′ 11c each of which correspond to a different data rate for uplink transmissions (from the UE to the Node Bs), arranged in order of increasing data rates, with a pointer 10a 10a′ 11a indicating a particular one of the TFCs as the maximum allowed, and so indicating the corresponding data rate as the maximum allowed. The TFCS is typically created by a serving Radio Network Controller (RNC) (not shown) and signaled to the Node Bs and to the UE via one or more of the Node Bs. Thus, a (maximum allowed data rate) pointer 11a is maintained by the UE 11 and (at least in case of differential signaling, which is assumed here unless otherwise indicated) a corresponding data rate pointer 10a 10a′ is maintained by each Node B 10 10′ controlling a respective radio link in the active set of the UE. The term pointer as used here is typically a data object used by executable code to point to a location in memory where a value of another data object is stored—in the case at hand, the other data object being a value for rate of uplink, as discussed below. However, the term pointer should be understood here as meaning any indicator of a value of a data object corresponding to a rate of uplink. For example, the term pointer as used here can mean an integer value used to indicate a particular entry in a one-dimensional array of different possible uplink values.

Still referring to FIG. 1, according to the prior art, the UE 11 is allowed to transmit in the uplink at or below the (maximum allowed) data rate (TFC) indicated by the UE pointer 11a (i.e. the instance/copy of the UE pointer in the UE, as opposed to the instance of the UE pointer in any of the Node Bs 10 10′ controlling a radio link in the active set of the UE), which ideally should always be the same as the Node B pointers 10a 10a′ (i.e. the instance/copy of the UE pointer in the Node Bs 10 10′ controlling respective radio links in the active set, as opposed to the instance of the UE pointer in the UE), but which sometimes differs during soft handover (SHO) for the reasons given above (as well as because of signaling errors); and the UE may request a rate increase from a Node B controlling a radio link in the active set as described below, and may receive a pointer increment command in response. As described below, a Node B controlling a radio link in the active set may also send an increment or decrement command to the UE without any UE request. The initial pointer value is (explicitly) signaled by the RNC (not shown) at a time other than during SHO to the (one and only) controlling Node B, which in turn (explicitly) signals the initial pointer value to the UE.

Still referring to FIG. 1, the invention solves the problem of having the UE 11 receive in parallel uplink rate commands from more than one Node B controlling a radio link in the active set by having the UE in effect designate a particular one of the Node Bs as the scheduler by selecting a cell among those cells it has a connection with via a respective radio link in its active set—i.e. as the one and only Node B entitled to issue commands affecting the (maximum allowed uplink data rate) pointer in the UE, and also makes possible changing the scheduler from one Node B to another as follows. When the UE 11 has more than one radio link (each of which is controlled by a different one of the Node Bs 10 10′) in its active set, it selects (according to criteria yet to be specified) which cell is to be what is here called the scheduling cell, and then transmits the identity of the scheduling cell in the uplink, using e.g. the mechanism specified in 3GPP Technical Specification (TS) 25.214, chapter 5.2.1.4, for identifying a particular cell in connection with SSDT. A Node B in general controls more than one cell, but no cell is controlled by more than one Node B. Each Node B 10 10′ receiving the uplink from the UE (and thus presumably each Node B controlling a respective radio link in the active set) then determines whether it is in control of the so-identified scheduling cell, and issues scheduling commands only if it is the Node B controlling the scheduling cell, in which case, as noted, it is here called the scheduler.

Now, when the scheduling cell changes (based e.g. on decisions made by the UE in connection with signal quality) from a current scheduling cell to a new scheduling cell, the UE transmits the identity of the new scheduling cell in the uplink, as before. As before, each Node B controlling a respective radio link in the active set determines whether it is the Node B in control of the (newly designated) scheduling cell. Now, if the change in scheduling cells is such that a the scheduler changes from the first Node B 10 to the second Node B 10′, then the second Node B 10′ begins sending scheduling commands to the UE 11 and the first Node B 10 stops sending scheduling commands.

Now as the data rate pointer of the UE was synchronized only to the data rate pointer of the Node B that was previously in control of the scheduling, it cannot be assumed that the data rate pointers of the UE and the newly selected scheduler have the same values. Thus, the invention also provides for synchronizing the data rate pointer of the UE 11 with that of the new scheduler, assumed here to be the second Node B 10′. The synchronizing is performed according to a pre-agreed or dynamically determined procedure, such as any of the procedures indicated below, typically requiring that synchronization steps be carried out by both the UE and the Node B newly assuming control of the scheduling.

As both the new scheduler Node B 10b′ and the UE 11 are aware—at the same time—that a change of the scheduler has occurred, the change itself can serve as a trigger for (maximum allowed data rate) pointer synchronization. The invention provides four alternative synchronization processes: First, the data rate pointers of both the UE and the new scheduler Node B can be set to point to the data rate (TFC) used when the UE was transmitting the change of scheduling cell (i.e. transmitting the identifier of the new scheduling cell) in the uplink. Second, the data rate pointers of both the UE and the new scheduler Node B are set at the time of the change to some predefined data rate (TFC). Third, the data rate pointers of both the UE and the new scheduler Node B are set according to some other criteria, known to both the UE and the Node B, based e.g. on the uplink TFC being used and previously signalled configuration. Fourth, the new scheduler Node B selects a value for the data rate pointer and explicitly signals the value to the UE.

The first two alternatives are simpler, but objections to each can be raised: in the first alternative, if the UE did not have any data to transmit at the time of the change of the scheduling cell, the maximum data rate ends up being the lowest possible; and in the second alternative, the pointer value would have to be set to some rather low value and if the UE was transmitting with a higher data rate before the change, then the cell's load control would have already coped with higher interference. In view of these separate difficulties for the first two alternatives, the invention also provides a fifth alternative that is in essence a combination of the first two alternatives. In the fifth alternative, the data rate is set to the greater of the values provided by the first two alternatives, i.e. it is set to the data rate used in the uplink of the scheduling cell or it is set to a predetermined value, whichever is greater.

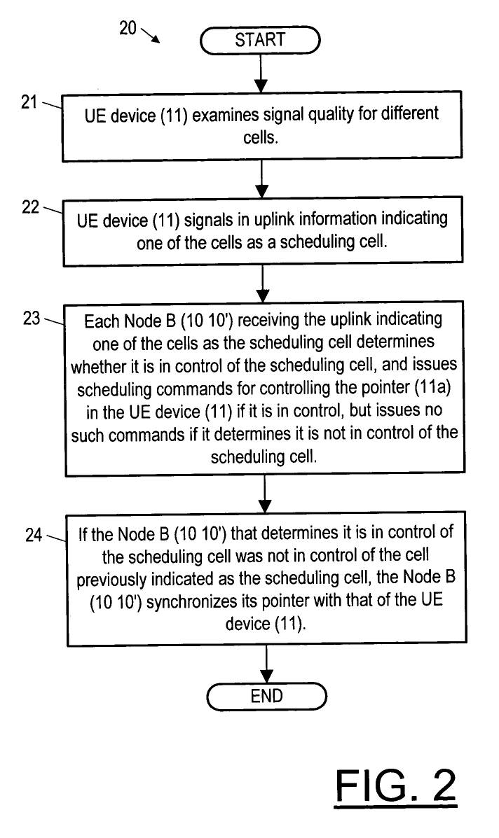

Referring now to FIG. 2 (and also to FIG. 1), the invention is shown in terms of a scenario (series of actions or steps taken by the RNC, Node Bs, and UE, steps that could, for the most part, be taken in any order and may not ever occur, depending on what errors or circumstances pertain, but are provided here as illustrative of steps by which the various devices—RNC, Node Bs, and UE—are operative according to the invention) including a first step 21 in which a UE device 11 examines signal quality for different cells. In a next step 22, the UE device 11 signals—in an uplink—information indicating one of the cells as a scheduling cell. In a next step 23, each Node B 10 10′ receiving the uplink indicating one of the cells as the scheduling cell determines whether it is in control of the scheduling cell, and issues scheduling commands for controlling the pointer 11a in the UE device 11 if it is in control of the cell indicated as the scheduling cell, but issues no such commands if it determines it is not in control of the scheduling cell. In a next step 24, if the Node B 10 10′ that determines it is in control of the scheduling cell was not, also in control of the cell previously indicated as the scheduling cell, the Node B 10 10′ synchronizes its pointer with that of the UE device 11 (and of course the UE also synchronizes its pointer according to whatever synchronization procedure is to be followed, and so the UE may also change its pointer).

Note that if the UE is not sending information indicating one of the cells as the scheduling cell (such as a cell identifier), the Node B currently acting as the Node B scheduler assumes no change has occurred and continues to serve as the Node B scheduler. Also, when the Node B that was previously controlling a cell that that was the scheduling cell determines (from the UE uplink) that the cell is no longer the scheduling cell, the Node B ceases processing scheduling requests from the UE and stops sending scheduling commands to the UE, and also removes the UE from its scheduling queue. Note however, that data transmission and reception is still active as usual for that UE via the Node B even when it does not serve as the scheduling Node B.

It should be understood also that the information indicating one of the cells as the scheduling cell may not be a message indicating a particular cell as the scheduling cell but may instead be, as with SSDT, a primary cell selection (indicating the cell as primary) and the Node B in control of the primary cell then determines whether certain signal reliability criteria for signals in the cell are met, and if so, treats the message indicating the primary cell as also a message indicating the scheduling cell.

Although in the above-described embodiments the Node Bs use differential signaling to control the (UE) pointer in the UE (i.e. the Node B signals e.g. increment the pointer value by one unit), as is clear from the above description, nothing about the invention limits it to differential signaling, and so the invention also comprehends embodiments in which explicit (absolute) signaling is used by the Node Bs (i.e. the Node Bs signal as described above a new pointer value p, as opposed to a simple increment or decrement pointer command).

Also, as mentioned above, it should be understood that the invention is of use not only in case of a change in scheduling cells that corresponds to a change in Node Bs (i.e. in case of soft handover), but also to a change in scheduling cells that does not (in softer handover). In other words in case a UE is both in soft handover and possibly also in softer handover, the invention is also of use, since even though sometimes a change in scheduling cells will not correspond to a change in Node Bs, at other times it will, and so there is still a need to keep all Node Bs except one from scheduling the UE. Note that if the old and new scheduling cells are controlled by the same Node B (so that the UE is in softer handover with that Node B but in soft handover with other Node Bs), synchronization is of course unnecessary.

Note also that in the case where a UE selects a cell without the functionality for scheduling as a primary cell, no scheduling occurs while that cell is the primary cell, and the UE may send scheduling signals (requests) but will not receive any scheduling signals (commands). When a cell with scheduling capability is then selected as a primary cell again, the scheduling will continue normally.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

1. A method for use by a user equipment (UE) device (11) and Node Bs (10 10′) of a wireless telecommunication system, the method for enabling Node B based control during soft handover of the maximum data rate allowed for uplink by the UE device (11) as indicated by a pointer (11a) in the UE device (11), the soft handover resulting in a change of a controlling Node B from a first one (10) of the Node Bs (10 10′) to a second one (10′) of the Node Bs (10 10′), each of the Node Bs (10 10′) for providing commands for control of UE devices in at least one respective cell so that the UE device (11) in soft handover is simultaneously in at least two cells each possibly controlled by a different one of the Node Bs (10 10′), the method characterized by:
a step (22) in which the UE device (11) signals in uplink information indicating one of the cells as a scheduling cell;
a step (23) in which each Node B (10 10′) receiving the uplink indicating one of the cells as the scheduling cell and able to provide scheduling commands determines whether it is in control of the scheduling cell, and issues scheduling commands for controlling the pointer (11a) in the UE device (11) if it is in control, but issues no such commands if it determines it is not in control of the scheduling cell.

2. The method of claim 1, further characterized by:
a step (24) in which the UE device (11) and also the Node B (10 10′) in control of the scheduling cell each synchronize a respective pointer (11a 10a 10a′) for indicating the maximum allowed uplink data rate for the UE device (11) to a value according to a synchronization procedure.

3. The method of claim 2, further characterized in that according to the synchronization procedure, the Node B (10 10′) sets the pointer (10a 10a′) it maintains to the data rate used in the uplink of the information indicating the scheduling cell.

4. The method of claim 2, further characterized in that according to the synchronization procedure, the Node B (10 10′) sets the pointer (10a 10a′) it maintains to a predetermined value.

5. The method of claim 2, further characterized in that according to the synchronization procedure, both the Node B (10 10′) and the UE device (11) set their respective pointers (10a 10a′ 11a) according to predetermined criteria.

6. The method of claim 2, further characterized in that according to the synchronization procedure, the Node B (10 10′) sets the pointer (10a 10a′) it maintains to a value it selects and explicitly signals the value to the UE device (11).

7. The method of claim 2, further characterized in that according to the synchronization procedure, the Node B (10 10′) sets the pointer (10a 10a′) it maintains to the data rate used in the uplink of the information indicating the scheduling cell or to a predetermined value, whichever is greater.

8. The method of claim 1, wherein the Node B based control is provided using differential signaling.

9. The method of claim 1, wherein the Node B based control is provided using explicit signaling.

10. A UE device (11), comprising:
means for wirelessly communicating with Node Bs of a radio access network in a wireless communication system;
a pointer (11a) for indicating a maximum allowed rate of uplink to the wireless communication system; and
means for adjusting the pointer responsive to scheduling commands received from a Node B (10 10′) controlling a cell in which the UE device (11) is located;
the UE device (11) characterized in that it comprises:
means for uplinking information indicating as a scheduling cell a particular cell from among a plurality of cells involved in a soft handover, each cell possibly controlled by a different Node B (10 10′).

11. A UE device (11) as in claim 10, further characterized in that the UE device (11) comprises:
means for selecting as a scheduling cell a particular cell from among a plurality of cells involved in a soft handover.

12. A UE device (11) as in claim 10, further characterized in that the UE device (11) comprises:
means for determining whether scheduling commands are sent by the Node B controlling the scheduling cell and for disregarding all scheduling commands sent by other than the Node B controlling the scheduling cell.

13. A UE device (11) as in claim 10, further characterized in that the UE device (11) further comprises:
means for synchronizing the pointer (11a) to a corresponding pointer (10a) in the Node B (10) controlling the scheduling cell.

14. A UE device (11) as in claim 13, further characterized in that for synchronization, the UE device (11) sets the pointer (11a) it maintains to the data rate used in the uplink of the information indicating the scheduling cell.

15. A UE device (11) as in claim 13, further characterized in that for synchronization, the UE device (11) sets the pointer (11a) it maintains to a predetermined value.

16. A UE device (11) as in claim 13, further characterized in that for synchronization, the UE device (11) sets the pointer (11a) it maintains according to predetermined criteria.

17. A UE device (11) as in claim 13, further characterized in that for synchronization, the UE device (11) sets the pointer (11a) it maintains to a value explicitly signalled by the Node B (10 10′).

18. A UE device (11) as in claim 13, further characterized in that for synchronization, the UE device (11) sets the pointer (11a) it maintains to the data rate used in the uplink of the information indicating the scheduling cell or to a predetermined value, whichever is greater.

19. A Node B (10 10′) comprising means for wirelessly communicating with a user equipment (UE) device (11) as an element of a radio access network of a wireless communication system, characterized in that it comprises:
means for determining when to assume control of scheduling of the UE device (11) and when to cease control of scheduling of the UE device (11) based on information uplinked by the UE device (11) indicating as a scheduling cell a particular cell from among a plurality of cells involved in a soft handover.

20. The Node B (10 10′) of claim 19, further comprising a pointer (10a 10a′) indicating a maximum allowed rate of uplink by the UE device (11), and further characterized in that it comprises:
means (24) by which the Node B (10 10′) synchronizes to the pointer (11a) in the UE device (11) a pointer (10a 10a′) it maintains for indicating the maximum allowed uplink data rate for the UE device (11).

21. The Node B (10 10′) of claim 20, further characterized in that for synchronization, the Node B (10 10′) sets the pointer (10a 10a′) it maintains to the data rate used in the uplink of the information indicating the scheduling cell.

22. The Node B (10 10′) of claim 20, further characterized in that for synchronization, the Node B (10 10′) sets the pointer (10a 10a′) it maintains to a predetermined value.

23. The Node B (10 10′) of claim 20, further characterized in that for synchronization, the Node B (10 10′) sets its pointer (10a 10a′) according to predetermined criteria.

24. The Node B (10 10′) of claim 20, further characterized in that for synchronization, the Node B (10 10′) sets the pointer (10a 10a′) it maintains to a value it selects and explicitly signals the value to the UE device (11).

25. The Node B (10 10′) of claim 20, further characterized in that for synchronization, the Node B (10 10′) sets the pointer (10a 10a′) it maintains to the data rate used in the uplink of the information indicating the scheduling cell or to a predetermined value, whichever is greater.

26. A system, comprising a plurality of UE devices (11) and a plurality of Node Bs (10 10′), characterized in that the UE device (11) is as recited in claim 10.

27. A system, comprising a plurality of UE devices (11) and a plurality of Node Bs (10 10′), characterized in that at least two of the Node Bs (10 10′) are as recited in claim 19.

28. A computer program product comprising: a computer readable storage structure embodying computer program code thereon for execution by a computer processor in a UE device (11), with said computer program code characterized in that it includes instructions for executing the steps recited in claim 1 as executed by a UE device (11).

29. A computer program product comprising: a computer readable storage structure embodying computer program code thereon for execution by a computer processor in a Node B (10 10′), with said computer program code characterized in that it includes instructions for executing the steps recited in claim 1 as executed by a Node B (10 10′).
